(19) United States
(12) Patent Application Publication
(10) Pub. No.: US 2012/0154266 A1
(43) Pub. Date: Jun. 21, 2012

(54) APPARATUS AND METHOD FOR CONTROLLING DATA IN PORTABLE TERMINAL

(75) Inventor: Yeon-Kyung CHO, Gyeongsangbuk-do (KR)

(73) Assignee: SAMSUNG ELECTRONICS CO., LTD., Gyeonggi-Do (KR)

(21) Appl. No.: 13/326,687

(22) Filed: Dec. 15, 2011

(30) Foreign Application Priority Data
Dec. 20, 2010 (KR) 10-2010-0130992

(51) Int. Cl. G09G 5/00

(52) U.S. Cl. 345/156

(57) ABSTRACT

Provided is an apparatus and method for controlling data in a portable terminal, which can control data in the portable terminal while minimizing the motion of both hands of a user of the portable terminal. An apparatus for controlling data in a portable terminal includes a plurality of sensors disposed at the sides of the portable terminal to detect data control actions, and a control unit for controlling the data according to the data control actions detected by the plurality of sensors.

### CLAIM OF PRIORITY

This application claims the benefit under 35 U.S.C. §119 of a Korean Patent Application filed in the Korean Intellectual Property Office on Dec. 20, 2010 and assigned Serial No. 10-2010-0130992, the entire disclosure of which is hereby incorporated by reference.

### BACKGROUND OF THE INVENTION

1. Field of the Invention

The present invention relates generally to an apparatus and method for controlling data in a portable terminal, and more particularly, to an apparatus and method for controlling data while minimizing both hand motion of a portable terminal user.

2. Description of the Related Art

Recently, portable terminals have evolved to provide a high speed data communication as well as a voice communication. For example, in the IMT-2000 mobile communication network, the portable terminal can perform high-rate data communication as well as voice communication. In this type of network, data processible by the portable terminal may include packet data and video data.

Most portable terminals are now equipped with a camera or a TV receiver. The portable terminal with a camera can capture images for transmission and also display moving pictures and still pictures. The portable terminal with a TV receiver can display the received video signals for viewing. Further, the portable terminals are now equipped with a touchscreen unit serving as an input unit and a display unit to control data display on the touchscreen unit though simple actions such as a screen touch and a screen drag.

In operation, a user of the portable terminal typically will hold the terminal with one hand and performs a screen touch/drag action with the other hand. However, the weight of the portable terminal may strain the wrist of the user during operation. Also, the user may be inconvenienced due to frequently moving/removing of the other hand to/from the screen of the portable terminal during data control.

### SUMMARY OF THE INVENTION

An exemplary embodiment of the present invention is to provide an apparatus and method for controlling data in a portable terminal, which can control data in the portable terminal while minimizing both hand motion of a user of the portable terminal.

According to an aspect of the present invention, an apparatus for controlling data in a portable terminal includes: a sensor unit including a plurality of sensors disposed at the sides of the portable terminal to detect data control actions; and a control unit for controlling the data according to the data control actions detected by the sensor unit.

According to another aspect of the present invention, a method for controlling data in a portable terminal includes: determining whether data control actions are detected by a plurality of sensors disposed at the sides of the portable terminal; and controlling the data according to the data control actions detected by the respective sensor.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a portable terminal according to an exemplary embodiment of the present invention;

FIG. 2A is a diagram illustrating a horizontal mode of a portable terminal according to an exemplary embodiment of the present invention;

FIG. 2B is a diagram illustrating a vertical mode of a portable terminal according to an exemplary embodiment of the present invention; and

FIGS. 3A and 3B are flow diagrams illustrating a process for controlling data in a portable terminal according to an exemplary embodiment of the present invention.

### DETAILED DESCRIPTION OF THE INVENTION

Exemplary embodiments of the present invention will be described below in detail with reference to the accompanying drawings where same reference numerals in the drawings denote like elements. The present invention may, however, be embodied in different forms and should not be construed as limited to the embodiments set forth herein; rather, these embodiments are provided so that this disclosure will be thorough and complete, and will fully convey the scope of the present invention to those skilled in the art.

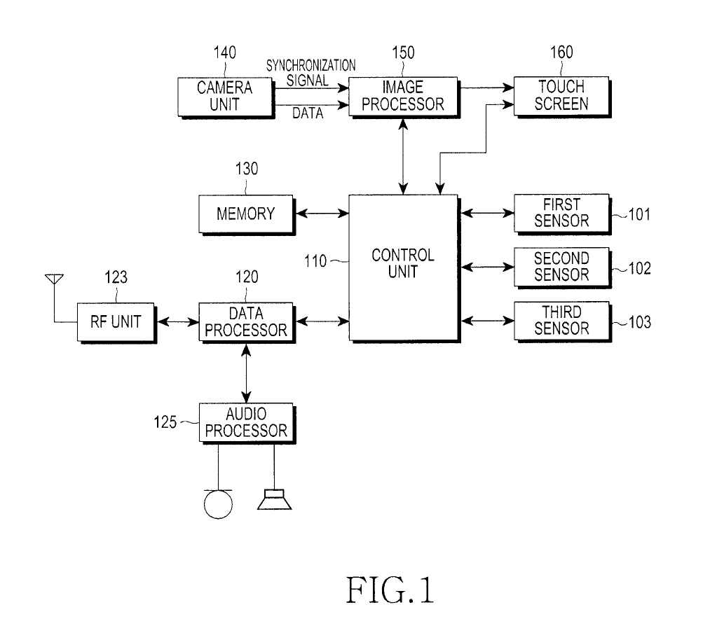

FIG. 1 is a block diagram of a portable terminal according to an exemplary embodiment of the present invention.

Referring to FIG. 1, a portable terminal according to an exemplary embodiment of the present invention includes a sensor unit, a control unit 110, a data processing unit 120, a radio frequency (RF) unit 123, an audio processing unit 125, a memory unit 130, a camera unit 140, a video processing unit 150, and a touchscreen unit 160. The sensor unit includes a first sensor 101, a second sensor 102, and a third sensor 103. Although three sensors are shown in FIG. 1 for illustrative purposes, it should be noted that more than three sensors can be applied according to the teachings of the present invention.

The RF unit 123 performs a wireless communication function of the portable terminal. The RF unit 123 includes an RF transmitter for upconverting and amplifying a TX signal, and an RF receiver for low-noise-amplifying and downconverting an RX signal. The data processing unit 120 includes a transmitter for encoding and modulating the TX signal, and a receiver for demodulating and decoding the RX signal. For example, the data processing unit 120 includes a modem and a codec. Herein, the codec includes a data codec for processing packet data, and an audio codec for processing audio signals (e.g., voice signals). The audio processing unit 125 processes an RX audio signal outputted from the audio codec of the data processing unit 120, and transmits a TX audio signal, generated by a microphone, to the audio codec of the data processing unit 120.

The memory unit 130 may include a program memory and a data memory. The program memory may store programs for controlling a general operation of the portable terminal, and programs for controlling data according to data control actions detected by the sensor unit.

The control unit 110 controls an overall operation of the portable terminal. In particular, the control unit 110 controls the data according to data control actions detected by the sensor unit. In an exemplary embodiment, the control unit 110 is configured to perform a horizontal scroll function or a vertical scroll function according to a horizontal movement or a vertical movement defined by the user's finger ativation detected by the sensor of the sensor unit. The control unit 110 is also configured to perform a zoom-out function or a zoom-in function according to a right movement and a down movement or a left movement and an up movement that are simultaneously detected by the two adjacent sensors of the sensor unit.

Further, the control unit 110 is configured to zoom in the display to a predetermined scale according to two consecutive inputs (e.g., a double tap) that are simultaneously detected by the two adjacent sensors of the sensor unit (hereinafter referred to as a double input) and to zoom out the zoomed-in display to the previous scale according to another double input in the two adjacent sensors of the sensor unit.

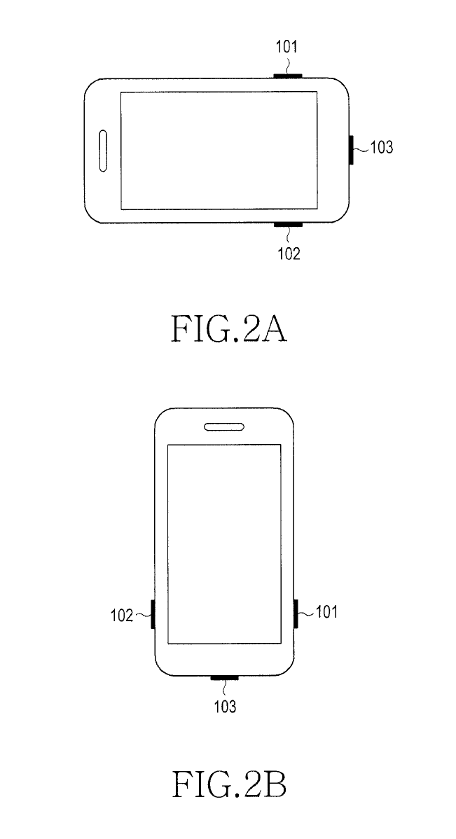

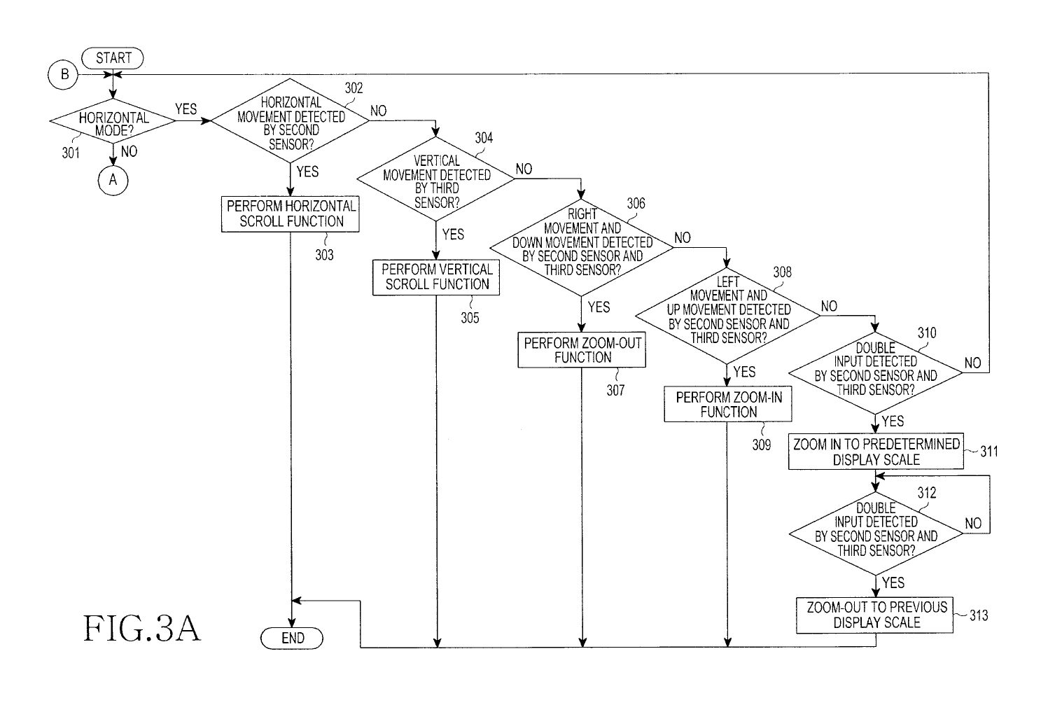

In an exemplary embodiment, as illustrated in FIG. 2A, the sensor unit includes the first sensor 101, the second sensor 102, and the third sensor 103 disposed at both sides and the bottom side of the portable terminal, and the control unit 110 controls data according to the data control actions detected by the second sensor 102 and the third sensor 103 touched with the thumb and the index finger of the right hand of the user when the portable terminal is in horizontal mode.

In operation, the control unit 110 is configured to perform a horizontal scroll function or a vertical scroll function according to a horizontal movement or a vertical movement detected by the second sensor 102 or the third sensor 103 when the portable terminal is in horizontal mode.

The control unit 110 is configured to perform a zoom-out function or a zoom-in function according to a right movement and a down movement, which are simultaneously detected by the second sensor 102 and the third sensor 103, or a left movement and an up movement, which are simultaneously detected by the second sensor 102 and the third sensor 103, when the portable terminal is in horizontal mode.

The control unit 110 is configured to zoom in the display to a predetermined scale according to a double input in the second sensor 102 and the third sensor 103 and to zoom out the zoomed-in display to the previous scale according to another double input in the second sensor 102 and the third sensor 103, when the portable terminal is in horizontal mode.

In an exemplary embodiment, as illustrated in FIG. 2B, the sensor unit includes the first sensor 101, the second sensor 102, and the third sensor 103 disposed at both sides and the bottom side of the portable terminal, and the control unit 110 controls data according to the data control actions detected by the third sensor 103 and the first sensor 101 touched with the thumb and the index finger of the right hand of the user when the portable terminal is in vertical mode.

In operation, the control unit 110 is configured to perform a horizontal scroll function or a vertical scroll function according to a horizontal movement or a vertical movement detected by the third sensor 103 or the first sensor 101 when the portable terminal is in the vertical mode.

The control unit 110 is configured to perform a zoom-out function or a zoom-in function according to a right movement and a down movement, which are simultaneously detected by the third sensor 103 and the first sensor 101, or a left movement and an up movement, which are simultaneously detected by the third sensor 103 and the first sensor 101, when the portable terminal is in vertical mode.

The control unit 110 is configured to zoom in the display to a predetermined scale according to a double input in the third sensor 103 and the first sensor 101 and to zoom out the zoomed-in display to the previous scale according to another double input in the third sensor 103 and the first sensor 101, when the portable terminal is in the vertical mode.

The sensors of the sensor unit are disposed at the sides of the portable terminal to detect data control actions, and the types and functions of the sensors detecting the data control actions vary according to the horizontal/vertical modes of the portable terminal. The sensors of the sensor unit may be any sensors that can detect data control actions such as a horizontal movement, a vertical movement, and an input.

As illustrated in FIGS. 2A and 2B, the portable terminal has the second sensor 102 and the first sensor 101 located at both sides thereof and the third sensor 103 located at the bottom side thereof. Herein, the second sensor 102 and the first sensor 101 may be symmetrical to each other and may be adjacent to the bottom side of the portable terminal.

Thus, as illustrated in FIG. 2A, when the portable terminal is in the horizontal mode, data may be controlled according to the data control actions detected by the second sensor 102 and the third sensor 103 touched with the thumb and the index finger of the right hand of the user.

As illustrated in FIG. 2B, when the portable terminal is in the vertical mode, data may be controlled according to the data control actions detected by the third sensor 103 and the first sensor 101 touched with the thumb and the index finger of the right hand of the user.

The camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). Also, the camera sensor and the signal processing unit may be integrated into one unit, or may be separated from each other.

A video processing unit 150 performs an image signal processing (ISP) operation to display video signals, outputted from the camera unit 140, on the touchscreen unit 160. Examples of the ISP operation include gamma correction, interpolation, spatial change, image effects, image scaling, auto white balance (AWB), auto exposure (AE), and auto focus (AF).

The video processing unit 150 processes the video signals, outputted from the camera unit 140, on a frame basis, and outputs the frame video data according to the size and characteristics of the touchscreen unit 160.

Also, the video processing unit 150 includes a video codec to compress the frame video data displayed on the touchscreen unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display screen size under the control of the control unit 110.

The touchscreen unit 160 may operate as a display unit and an input unit. When operating as a display unit, the touchscreen unit 160 may display video signals outputted from the video processing unit 150 and may display user data outputted from the control unit 110. When operating as an input unit, the touchscreen unit 160 may display keys for inputting numeral and character information and function keys for setting various functions.

Hereinafter, a process for controlling data in the portable terminal according to an exemplary embodiment of the present invention will be described below in detail with reference to FIGS. 1, 2A, 2B, 3A and 3B.

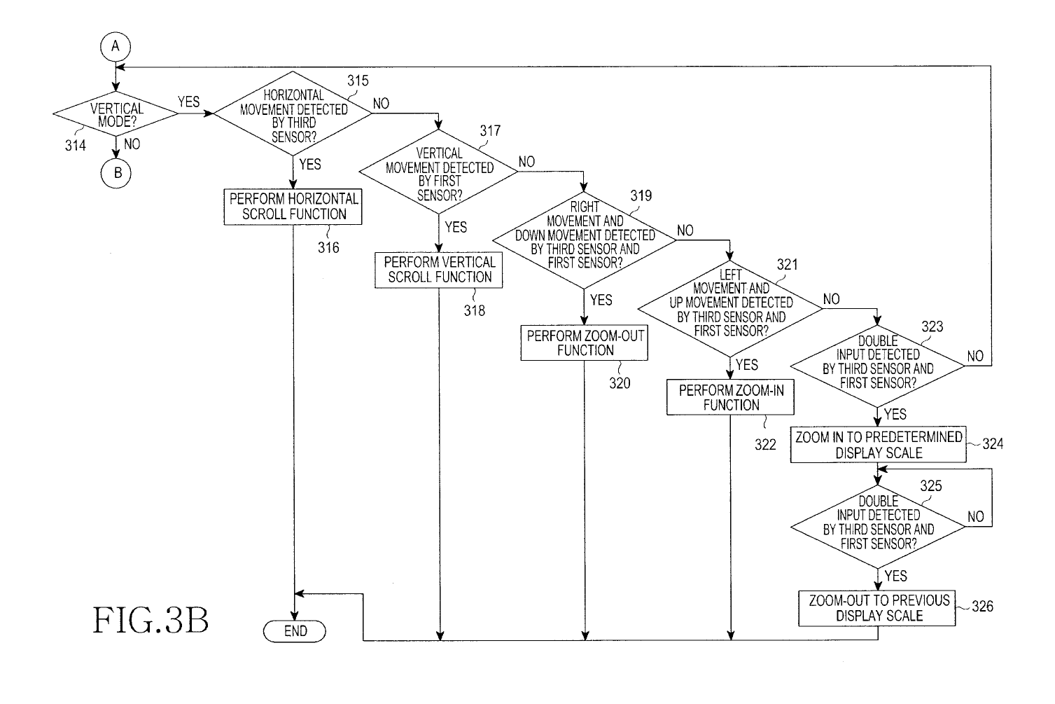

FIGS. 3A and 3B are flow diagrams illustrating a process for controlling data in the portable terminal according to an exemplary embodiment of the present invention.

The following description is made on the assumption that the portable terminal has the sensor unit including the first sensor, the second sensor, and the third sensor disposed at both sides and the bottom side of the portable terminal. However, it should be noted that other combination of sensors can be provided at different location in the terminal to perform the equivalent function, thus the exact location of the sensors taught herein should not limit the scope of the invention.

Referring to FIG. 3A, when the portable terminal is in horizontal mode as illustrated in FIG. 2A, the control unit 110 detects this in step 301 and waits to receive a detection signal from the second sensor 102 and the third sensor 103 touched with the thumb and the index finger of the right hand of the user.

When a horizontal movement/activation on the sensor is detected by the second sensor 102 during the display of data in the horizontal mode of the portable terminal, the second sensor 102 detects this and transmits a horizontal movement detection signal to the control unit 110. When receiving the horizontal movement detection signal from the second sensor 102, the control unit 110 detects the generation of the horizontal movement in the second sensor 102 in step 302 and performs a horizontal scroll function on the data according to the horizontal movement speed in step 303.

When a vertical movement/activation on the sensor is detected by the third sensor 103 during the display of data in the horizontal mode of the portable terminal, the third sensor 103 detects this and transmits a vertical movement detection signal to the control unit 110. When receiving the vertical movement detection signal from the third sensor 103, the control unit 110 detects the generation of the vertical movement in the third sensor 103 in step 304 and performs a vertical scroll function on the data according to the vertical movement speed in step 305.

When a right movement/activation of the user's finger on the sensor is detected by the second sensor 102 during the display of data in the horizontal mode of the portable terminal, the second sensor 102 detects this and transmits a right movement detection signal to the control unit 110. Also, when a down movement is simultaneously detected by the third sensor 103, the third sensor 103 detects this and transmits a down movement detection signal to the control unit 110.

When simultaneously receiving the right movement detection signal and the down movement detection signal from the second sensor 102 and the third sensor 103, the control unit 110 detects the simultaneous generation of the right movement and the down movement in the second sensor 102 and the third sensor 103 in step 306, and in turn performs a zoom-out function on the data according to the frequency of the simultaneous generation of the right movement and the down movement in the second sensor 102 and the third sensor 103 in step 307.

When a left movement is detected by the second sensor 102 during the display of data in the horizontal mode of the portable terminal, the second sensor 102 detects this and transmits a left movement detection signal to the control unit 110. Also, when an up movement is simultaneously detected by the third sensor 103, the third sensor 103 detects this and transmits an up movement detection signal to the control unit 110.

When simultaneously receiving the left movement detection signal and the up movement detection signal from the second sensor 102 and the third sensor 103, the control unit 110 detects the simultaneous generation of the left movement and the up movement in the second sensor 102 and the third sensor 103 in step 308 and performs a zoom-in function on the data according to the frequency of the simultaneous generation of the left movement and the up movement in the second sensor 102 and the third sensor 103 in step 309.

When a double input of finger being touched on the sensor twice is detected by the second sensor 102 during the display of data in the horizontal mode of the portable terminal, the second sensor 102 detects this and transmits a double input detection signal to the control unit 110. Also, when a double input is simultaneously detected by the third sensor 103, the third sensor 103 detects this and transmits a double input detection signal to the control unit 110.

When simultaneously receiving the double input detection signals from the second sensor 102 and the third sensor 103, the control unit 110 detects the simultaneous generation of the double inputs in the second sensor 102 and the third sensor 103 in step 310 and zooms in the data display to a predetermined scale in step 311.

Thereafter, when receiving the double input detection signals again from the second sensor 102 and the third sensor 103 simultaneously while the data display is zoomed in to the predetermined scale, the control unit 110 detects the simultaneous generation of the double inputs in the second sensor 102 and the third sensor 103 in step 312 and zooms out the zoomed-in data display to the previous scale in step 313.

Referring to FIG. 3B, when the portable terminal is in vertical mode as illustrated in FIG. 2B, the control unit 110 detects this in step 314 and waits to receive a detection signal from the third sensor 103 and the first sensor 101 touched with the thumb and the index finger of the right hand of the user.

When a horizontal movement is detected by the third sensor 103 during the display of data in the vertical mode of the portable terminal, the third sensor 103 detects this and transmits a horizontal movement detection signal to the control unit 110.

When receiving the horizontal movement detection signal from the third sensor 103, the control unit 110 detects the generation of the horizontal movement in the third sensor 103 in step 315 and performs a horizontal scroll function on the data according to the horizontal movement speed in step 316.

When a vertical movement is detected by the first sensor 101 during the display of data in the vertical mode of the portable terminal, the first sensor 101 detects this and transmits a vertical movement detection signal to the control unit 110.

When receiving the vertical movement detection signal from the first sensor 101, the control unit 110 detects the generation of the vertical movement in the first sensor 101 in step 317 and performs a vertical scroll function on the data according to the vertical movement speed in step 318.

When a right movement is detected by the third sensor 103 during the display of data in the vertical mode of the portable terminal, the third sensor 103 detects this and transmits a right movement detection signal to the control unit 110. Also, when a down movement is simultaneously detected by the first sensor 101, the first sensor 101 detects this and transmits a down movement detection signal to the control unit 110.

When simultaneously receiving the right movement detection signal and the down movement detection signal from the third sensor 103 and the first sensor 101, the control unit 110 detects the simultaneous generation of the right movement and the down movement in the third sensor 103 and the first sensor 101 in step 319 and performs a zoom-out function on the data according to the frequency of the simultaneous generation of the right movement and the down movement in the third sensor 103 and the first sensor 101 in step 320.

When a left movement is detected by the third sensor 103 during the display of data in the vertical mode of the portable terminal, the third sensor 103 detects this and transmits a left movement detection signal to the control unit 110. Also, when an up movement is simultaneously detected by the first sensor 101, the first sensor 101 detects this and transmits an up movement detection signal to the control unit 110.

When simultaneously receiving the left movement detection signal and the up movement detection signal from the third sensor 103 and the first sensor 101, the control unit 110 detects the simultaneous generation of the left movement and the up movement in the third sensor 103 and the first sensor 101 in step 321 and performs a zoom-in function on the data according to the frequency of the simultaneous generation of the left movement and the up movement in the third sensor 103 and the first sensor 101 in step 322.

Similar to FIG. 3a, when a double input is detected by the third sensor 103 during the display of data in the vertical mode of the portable terminal, the third sensor 103 detects this and transmits a double input detection signal to the control unit 110. Also, when a double input is simultaneously detected by the first sensor 101, the first sensor 101 detects this and transmits a double input detection signal to the control unit 110.

When simultaneously receiving the double input detection signals from the third sensor 103 and the first sensor 101, the control unit 110 detects the simultaneous generation of the double inputs in the third sensor 103 and the first sensor 101 in step 323 and zooms in the data display to a predetermined scale in step 324.

Thereafter, when receiving the double input detection signals again from the third sensor 103 and the first sensor 101 simultaneously while the data display is zoomed in to the predetermined scale, the control unit 110 detects the simultaneous generation of the double inputs in the third sensor 103 and the first sensor 101 in step 325 and zooms out the zoomed-in data display to the previous scale in step 326.

Although the data control operation of the present invention has been described in the context of the sensors disposed for the right-handed user, it may be similarly applicable to the case of disposing the sensors for the left-handed user. Although the data control actions detected by the sensor unit have been described in the context of the scroll function, the zoom-out/in function, and the function of zooming in to a predetermined scale, the data control operation may be similarly performed while performing a predetermined function through various other actions detected by the sensor unit.

As described above, the present invention provides an apparatus and method for controlling data in a portable terminal, which can control the data while minimizing the motion of both hands of the user of the portable terminal, and can protect the wrist of the user by reducing the load of lifting the portable terminal with one hand. Note either left or right hand can be used according to the teachings of the present invention.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for controlling data in a portable terminal, comprising:
a plurality of sensors provided at the sides of the portable terminal to detect data control actions; and
a control unit for controlling the data according to the data control actions detected by the plurality of sensors.

2. The apparatus of claim 1, wherein the types and functions of the sensors detecting the data control actions vary according to a horizontal or vertical orientation of the portable terminal.

3. The apparatus of claim 1, wherein the control unit
performs a horizontal scroll function or a vertical scroll function according to a horizontal movement or a vertical movement detected by at least one of the sensors.
performs a zoom-out function or a zoom-in function according to a right movement and a down movement or a left movement and an up movement that are simultaneously detected by the two adjacent sensors.

4. The apparatus of claim 1, wherein the control unit
zooms in or zooms out to a predetermined scale according to double inputs that are simultaneously detected by the two adjacent sensors.

5. The apparatus of claim 1, wherein a first sensor and a second sensor are provided at opposite ends of the portable terminal and a third sensor is provided at a bottom end of the portable terminal.

6. The apparatus of claim 5, wherein the control unit controls the data according to the data control actions detected by the second sensor and the third sensor during a horizontal mode of the portable terminal, and controls the data according to the data control actions detected by the third sensor and the first sensor during a vertical mode of the portable terminal.

7. The apparatus of claim 6, wherein the control unit:
performs a horizontal scroll function or a vertical scroll function according to a horizontal movement or a vertical movement detected by the second sensor and the third sensor during the horizontal mode of the portable terminal;
performs a zoom-out function or a zoom-in function according to a right movement and a down movement or a left movement and an up movement that are simultaneously detected by the second sensor and the third sensor; and
zooms in or out a predetermined scale according to double inputs that are simultaneously detected by the second sensor and the third sensor.

8. The apparatus of claim 6, wherein the control unit:
performs a horizontal scroll function or a vertical scroll function according to a horizontal movement or a vertical movement detected by the third sensor and the first sensor during the vertical mode of the portable terminal;
performs a zoom-out function or a zoom-in function according to a right movement and a down movement or a left movement and an up movement that are simultaneously detected by the third sensor and the first sensor; and
zooms in or out to a predetermined scale according to double inputs that are simultaneously detected by the third sensor and the first sensor.

9. The apparatus of claim 1, wherein controlling the data according to the data control actions detected by the plurality of sensors according to the data control actions is performed using a single hand.

10. A method for controlling data in a portable terminal, comprising:
determining whether data control actions are detected by a plurality of sensors disposed at the sides of the portable terminal; and
controlling the data according to the data control actions detected by the plurality of sensors.

11. The method of claim 10, wherein the types and functions of the sensors detecting the data control actions vary according to a horizontal or vertical orientation of the portable terminal.

12. The method of claim 10, wherein the controlling of the data comprises:
performing a horizontal scroll function according to a horizontal movement that is detected by at least one of the sensors;
performing a vertical scroll function according to a vertical movement that is detected by at least one of the sensors;
performing a zoom-out function according to a right movement and a down movement that are simultaneously detected by the two adjacent sensors; and
performing a zoom-in function according to a left movement and an up movement that are simultaneously detected by the two adjacent sensors.

13. The method of claim 10, wherein the controlling of the data comprises: zooming in or out to a predetermined scale according to double inputs that are simultaneously detected by the two adjacent sensors.

14. The method of claim 10, wherein a first sensor and a second sensor are provided at both opposite ends of the portable terminal and a third sensor is provided at a bottom end of the portable terminal.

15. The method of claim 14, wherein the controlling of the data comprises:
controlling the data according to the data control actions detected by the second sensor and the third sensor in the horizontal mode of the portable terminal, and controlling the data according to the data control actions detected by the third sensor and the first sensor in the vertical mode of the portable terminal.

16. The method of claim 14, wherein the controlling of the data in the horizontal mode of the portable terminal comprises:
performing a horizontal scroll function according to a horizontal movement that is detected by the second sensor;
performing a vertical scroll function according to a vertical movement that is detected by the third sensor;
performing a zoom-out function according to a right movement and a down movement that are simultaneously detected by the second sensor and the third sensor;
performing a zoom-in function according to a left movement and an up movement that are simultaneously detected by the second sensor and the third sensor;
zooming in to a predetermined scale according to double inputs that are simultaneously detected by the second sensor and the third sensor; and
zooming out the zoomed-in to a previous scale according to double inputs that are simultaneously detected by the second sensor and the third sensor.

17. The method of claim 14, wherein the controlling of the data in the vertical mode of the portable terminal comprises:
performing a horizontal scroll function according to a horizontal movement that is detected by the third sensor;
performing a vertical scroll function according to a vertical movement that is detected by the first sensor;
performing a zoom-out function according to a right movement and a down movement that are simultaneously detected by the third sensor and the first sensor;
performing a zoom-in function according to a left movement and an up movement that are simultaneously detected by the third sensor and the first sensor;
zooming in the display to a predetermined scale according to double inputs that are simultaneously detected by the third sensor and the first sensor; and
zooming out to a previous scale according to double inputs that are simultaneously detected by the third sensor and the first sensor.

18. The method of claim 10, wherein controlling the data according to the data control actions detected by the plurality of sensors according to the data control actions is performed using a single hand.
